(19) United States
(12) Patent Application Publication
(10) Pub. No.: US 2006/0293142 A1
(43) Pub. Date: Dec. 28, 2006

(54) Compact planetary gear assembly

(76) Inventors: Mariano Galan Torres, Madrid (ES); Alfred Sigmund Smemo, Dubuque, IA (US)

Correspondence Address: DEERE & COMPANY, ONE JOHN DEERE PLACE, MOLINE, IL, 61265, US

(21) Appl. No.: 11/165,968

(22) Filed: Jun. 24, 2005

(51) Int. Cl. F16H 37/08

(52) U.S. Cl. 475/331

(57) ABSTRACT

A planetary gear assembly for a final drive with an external surface. Planetary gears are assembled in an integrated planetary gear carrier in which the external surface of the final drive forms a part of the carrier. The external surface is continuous in the vicinity of each planetary gear in the assembly, i.e., there are no holes in the external surface associated with the connection of the planetary gears to the integrated planetary gear carrier.

### FIELD OF THE INVENTION

The invention relates to planetary gear systems and, more particularly, relates to compact planetary gear assemblies for final drives providing a reduction in the number of leak paths between the internal and external environments of the final drive and providing additional compactness by integrating several functions in a single part.

### BACKGROUND OF THE INVENTION

Conventional planetary gear assemblies include planetary gear carriers with a through hole, i.e., a potential leak path, proximate to each planetary gear mounted on the carrier as well as other necessary holes, including oil fill and oil drain holes. Such arrangements necessitate additional sealing arrangements to protect each potential leak path from potential contamination in an operating environment external to the drive system.

### SUMMARY OF THE INVENTION

Additional sealing arrangements necessitated by the greater number of leak paths in conventional planetary gear carriers generally add to the size and complexity as well as the cost of the planetary gear assemblies. Further, there is an added maintenance risk associated with each additional part and each potential leak path. Thus, the overall reliability of the planetary gear assembly tends to go down and the overall cost tends to go up as the number of leak paths to the outside environment increase.

Described herein is an invention in which the number of parts and potential leak paths between the planetary gear carrier and the outside environment is substantially reduced and potential leak paths proximate to each mounted planetary gear are eliminated. Additionally, the invention allows a substantial reduction in axial space requirements for planetary gear assemblies in final drives by integrating several functions into a one piece planetary gear carrier. Further, in the described invention, the risk of damage from contact with foreign objects is minimized as the planetary gear assemblies are sealed from the outside environment by an outer wall of the planetary gear carrier.

### BRIEF DESCRIPTION OF THE DRAWINGS

Embodiments of the invention will be described in detail, with references to the following figures, wherein:

FIG. 1 illustrates a section view of an exemplary embodiment illustrated in Fig.;

FIG. 2 is an exploded view of an exemplary embodiment of the invention; and

FIG. 3 illustrates an exemplary embodiment of the planetary gear carrier.

### DESCRIPTION OF THE ILLUSTRATED EMBODIMENT

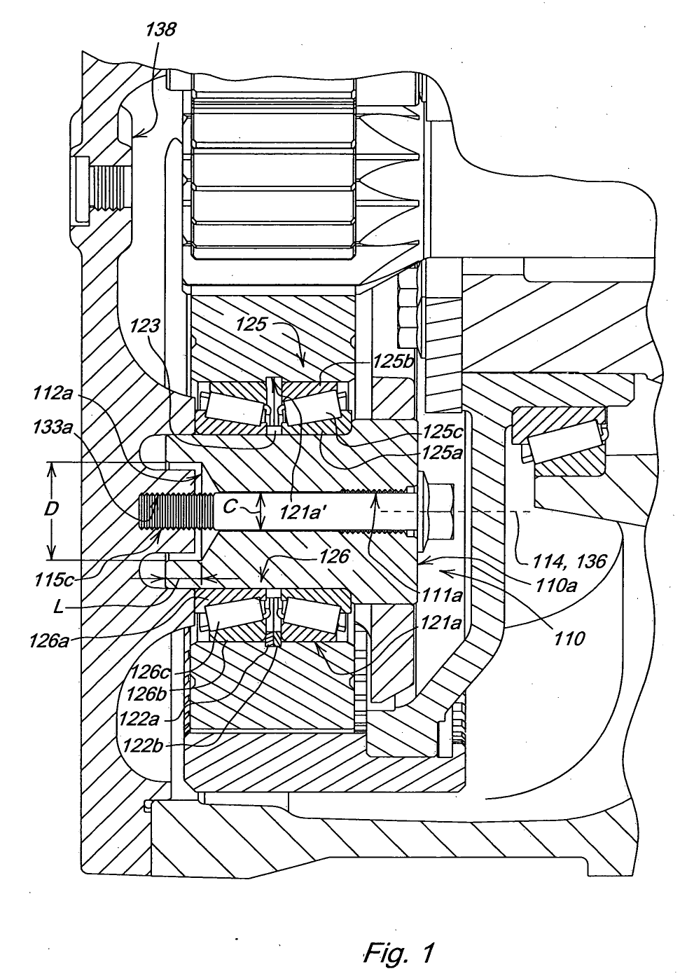

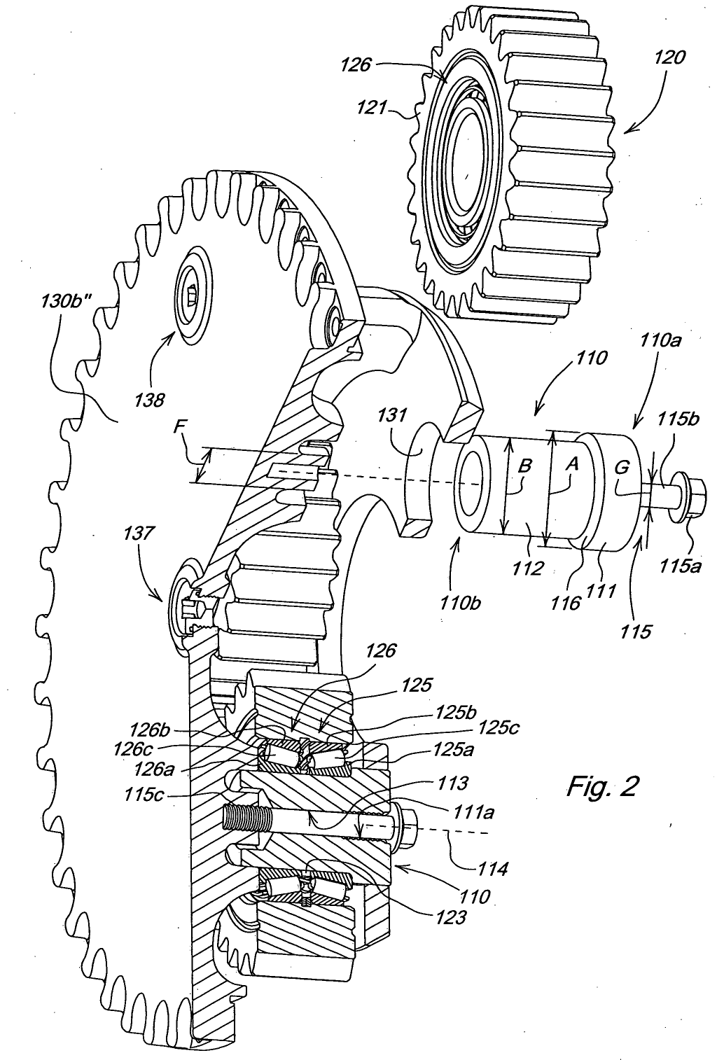

FIG. 1 illustrates a sectioned view of an, exemplary embodiment of the invention and FIG. 2 illustrates an exploded view of the exemplary embodiment of the FIG. 1, i.e., a planetary gear assembly 100. Included in the planetary gear assembly 100 is a planetary pinion shaft 110; a planetary pinion gear assembly 120 including a planetary pinion gear 121, two snap rings 122a and 122b, a spacer 123, and two tapered roller bearings 125 and 126 having races 125a, 126a, cups 125b, 126b and roller cage assemblies 125c, 126c; a pinion shaft assembly screw 115 having a head 115a, a shank 115b and a screw thread 115c; and a one piece planetary gear carrier 130. The planetary pinion gear 121 includes a mounting surface 121a with a positioning groove 121a′.

As illustrated in FIG. 2, the planetary pinion shaft 110 has a first shaft end 110a, a second shaft end 110b, a first external cylindrical shaft surface 111 having a first external shaft diameter A, a second external cylindrical shaft surface 112 having a second external shaft diameter B, a shaft through hole 113 having a first inner diameter C, and a threaded hole having a shaft thread 111a with each having a common centerline 114. The smallest diameter of the shaft thread 111a is greater than the diameter G of the shank 115b and the greatest diameter of the screw thread 115c. The transition between the first and second external cylindrical surfaces 111, 112 is abrupt and formed by shoulder 116, a surface which is, in large part, orthogonal to the centerline 114. Finally, the planetary pinion shaft 110 includes a recessed shaft area 112a at the second end 110b having an internal diameter D and a length L.

The planetary gear carrier 130 is a machined metal casting which includes an inner carrier structure 130a, an outer carrier structure 130b and three pillars 130c connecting the inner carrier structure 130a and the outer carrier structure 130b. The inner carrier structure 130a contains three equally spaced inner carrier holes 131 having diameters E and one central carrier hole 135 through which the drive shaft and integral sun gear (not shown) project. The outer carrier structure 130b includes a first outer structure side 130b′ and a second outer structure side 130b″. The first outer carrier side 130b′ includes three carrier socket structures 132, an oil fill hole 137 and an oil drain hole 138. Each carrier socket structure 132 includes a first carrier socket surface 132a, i.e., a female structure, having a first socket diameter E; a second socket surface 132b, i.e., a male structure, having a second socket diameter F; a first carrier socket abutment 132c and a second carrier socket abutment 132d. Central to each carrier socket structure 132 is a blind threaded carrier hole 133 having a thread 133a to mate with the screw thread 115c. Ideally, each inner carrier hole 131 and corresponding carrier socket structure 132, especially with respect to the female socket surface 132a, have a common centerline 136. As illustrated, the second outer structure side 130b″ includes a surface that is continuous but for the oil fill, oil drain and attachment holes.

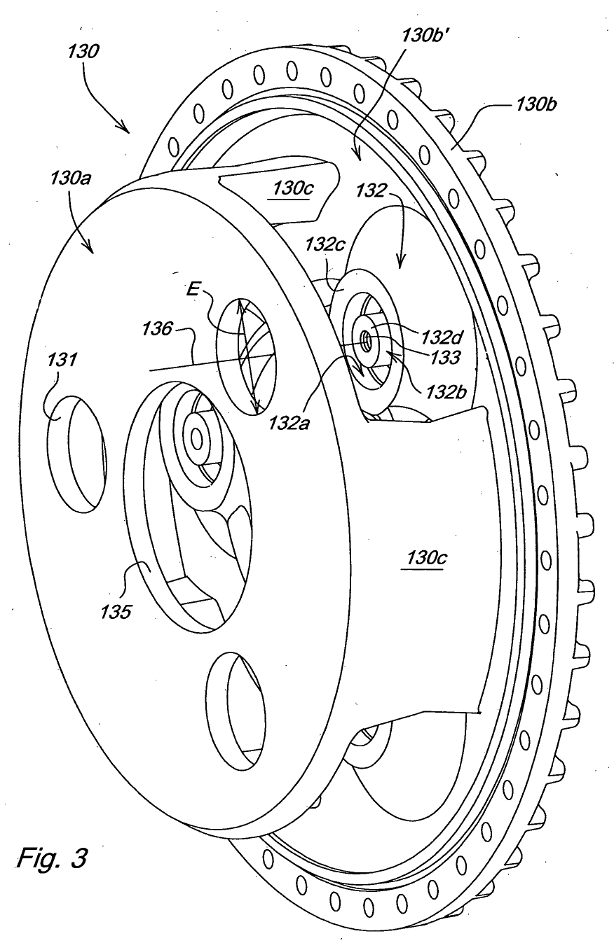

As illustrated in FIGS. 1 and 2, in the planetary gear assembly 100, the tapered roller bearings 125, 126 are mounted on a portion of the second external surface 112 and the planetary pinion gear 120 is mounted on the tapered roller bearings 125, 126. The pinion shaft 110 is mounted on the planetary gear carrier 130 such that the recessed shaft area 112a mates with the socket structure 132 and the first cylindrical surface 111 mates with the carrier hole 131. The screw 115 is assembled such that the screw thread 115c sufficiently engages the socket thread 133a and the head 115a engages the first end 110a. The pinion shaft 110 and the roller races 125a, 126a and spacer 123 are dimensioned to be fully engaged prior to the full engagement of second carrier socket surface 132b and the recessed shaft area 112a. Thus, as illustrated in FIGS. 1, 2 and 3, the second carrier socket surface 132b does not contact the recessed shaft area 112a either radially, via the second carrier socket surface 132b, or axially, via the second carrier socket abutment 132d in the completed planetary gear assembly 100. In the planetary gear assembly 100, the first cylindrical shaft surface 112 forms an interference fit with the inner carrier hole 131 and the second cylindrical shaft surface 111 forms an interference fit with the first carrier socket surface 132a to restrict rotational movement of the planetary pinion shaft 110. Axial movement of the pinion shaft 110 is restrained via the actions of the pinion shaft assembly screw 115, the planetary pinion gear assembly 120 and the socket abutment 132c.

The planetary gear assembly 100 may be produced in a step by step process by assembling the innermost parts first. The snap rings 122a and 122b are installed in the groove 121a′ of the planetary pinion gear 121. The bearing cups 125b, 126b are then pressed into the mounting surface 121a as illustrated in FIG. 1. The roller assemblies 125c, 126c, the bearing cones 125a, 126a and the spacer 123 are then installed as illustrated to form the planetary pinion gear assembly 120. The planetary gear assembly 120 is then properly positioned in the planetary gear carrier 130 between a carrier hole 131 and a corresponding socket structure 132. The planet pinion shaft 110 is then pressed into the carrier hole 131, the races 125a, 126a and the first socket surface 132a until its lateral movement is stopped via action of the shoulder 116, the races 125a, 126a, the spacer 123 and the first socket abutment 132c as illustrated. The shaft assembly screw 115 is then passed through the shaft and attached to the socket structure by engaging the screw thread 115c with the socket thread 133a. Note that all assembly is accomplished from one side of the planetary gear carrier 130, affording greater ease and efficiency during the assembly process. Further, very few parts are exposed on the second outer carrier side 130b″. This leads to fewer maintenance problems due to damaged or loosened parts due to exposure to the external environment.

Removal of the planetary pinion gear assembly is accomplished by disengaging the screw thread 115c from the socket thread 133a and removing the shock assembly screw from the planetary gear assembly 100. A thread of a second screw such as, for example, an eyebolt (not shown) is then engaged with the thread 111a, an axial force sufficient to remove the planetary pinion shaft 110 is applied to the second screw, and the planetary pinion shaft 110 is removed from what remains of the planetary gear assembly 100.

Having described the illustrated embodiment, it will become apparent that various modifications can be made without departing from the scope of the invention as defined in the accompanying claims.

1. A planetary gear assembly for a final drive having an external surface, comprising:
a planetary pinion gear;
a bearing;
a planetary pinion shaft having a shaft centerline; and
an integrated planetary gear carrier having an inner carrier structure and an outer carrier structure, the outer carrier structure including a first outer structure side having a first outer structure surface and a second outer structure side having a second outer structure surface, the second outer structure surface facing a direction that is generally opposite to that of a direction faced by the first outer structure surface, the planetary pinion gear, the bearing and the planetary pinion shaft forming a planetary gear assembly, the planetary gear assembly being assembled in a planetary gear arrangement between the inner carrier structure and the first outer structure side, the second portion having a continuous surface proximate to the shaft centerline in the planetary gear arrangement.

2. The planetary gear assembly of claim 1, wherein the planetary pinion shaft has a first shaft end with a first outer shaft diameter and a second shaft end with a second outer shaft diameter, the first outer shaft diameter being larger than the second outer shaft diameter.

3. The planetary gear assembly of claim 2, wherein the first outer structure side includes a socket having a first inner socket diameter, the socket forming an interference fit with the first outer shaft diameter and the inner carrier structure includes an inner carrier hole having an inner carrier hole diameter, the inner carrier hole forming an interference fit with the second outer shaft diameter.

4. The planetary gear assembly of claim 2, wherein the second shaft end includes a recessed shaft area, a portion of the planetary pinion shaft being located between the recessed shaft area and the second outer shaft diameter and forming a circular ridge.

5. The planetary gear assembly of claim 4, wherein the first outer structure side includes a groove sized to receive the circular ridge, a larger diameter of the groove being the first groove diameter.

6. The planetary gear assembly of claim 4, wherein the planetary pinion shaft includes a through hole having a hole centerline along the shaft centerline and a first end surface orthogonal to the shaft centerline, the through hole having a first shaft hole diameter at the first end and a second shaft hole diameter at the second end, the first shaft hole diameter being greater than the second shaft hole diameter, the first shaft hole diameter having an internal shaft thread.

7. The planetary gear assembly of claim 6, further comprising an attachment screw having an external screw thread and a screw head for attaching the planetary pinion shaft to the planet pinion carrier.

7. The planetary gear assembly of claim 6, wherein the hole centerline lies along the shaft centerline.

8. The planetary gear assembly of claim 6, wherein the first outer structure side includes a blind hole having an internal socket thread designed to mate with the external screw thread, the attachment screw being attached such that the screw head rests on the first end surface and the external screw thread is engaged with the internal socket thread.

9. The planetary gear assembly of claim 1,.wherein the integrated planetary gear carrier comprises a one piece machined metal casting.

10. A planetary gear assembly, comprising:
a planetary pinion gear having a cylindrical gear mounting surface forming an inner gear diameter, the cylindrical gear mounting surface including an annular groove;
a planetary pinion shaft having a centerline, a through hole having an inner diameter, a first cylindrical shaft portion having a first outer shaft diameter and a second cylindrical shaft portion having a second outer shaft diameter;
a pinion shaft screw having an external screw thread and a screw head;
a first tapered roller bearing having a first race and a first cup, the first race having a first race mounting surface, the first cup having a first cup mounting surface;
a second tapered roller bearing having a second race and a second cup, the second race having a second race mounting surface, the second cup having a second cup mounting surface;
an integrated planetary gear carrier, the integrated planetary gear carrier including a first carrier structure including a hole having a first inner cylindrical diameter providing an interference fit with the first outer shaft diameter, a second carrier structure, the second carrier including a socket structure having a blind bore surface with a first socket diameter providing an interference fit with the second outer shaft diameter, a blind hole having a blind hole thread matching the external screw thread and a socket abutment between the blind hole and the blind bore surface, the planetary pinion shaft being seated in the socket structure, the first and second race mounting surfaces forming interference fits with the second cylindrical shaft portion, the first and second cup mounting surfaces forming interference fits with the second cylindrical gear mounting surface, the snap ring assembled to the groove and separating the first and second cups, the spacer separating the first and second races.

11. The planetary gear assembly of claim 10, further comprising a shaft abutment as a transition between the first external diameter and the second external diameter, a lateral movement of the first race being constrained by the shaft abutment, a lateral movement of the second race being constrained by the socket abutment.

12. The planetary gear assembly of claim 10, wherein the integrated planetary gear carrier comprises a one piece machined metal casting.
